(19) United States
(12) Patent Application Publication
(10) Pub. No.: US 2006/0072226 A1
(43) Pub. Date: Apr. 6, 2006

(54) Remote viewing amplifier

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 10/957,391

(22) Filed: Oct. 2, 2004

(51) Int. Cl. G02B 1/00

(52) U.S. Cl. 359/896; 359/894

(57) ABSTRACT

An apparatus which enhances the ability of a person to perform remote viewing by connecting the human spiritual eye to the tetrahedral geometry of subspace.

### BRIEF SUMMARY OF THE INVENTION

This invention enhances the ability of a person to perform remote viewing by connecting the spiritual eye to the tetrahedral geometry of subspace.

### BACKGROUND OF THE INVENTION

Remote viewing is the projection of spiritual modules of the human energy field to distant locations in order to see, communicate and interact with other entities who live in subspace, space and hyperspace co-dimensions of the universe.

One of my first remote viewings was made at night to a distance of 10,000 miles on the sunlit side of the earth. My spiritual eye and body projected together while my mental facilities remained in my physical body. I found myself looking down on a palm tree from a height of about one hundred feet. The palm tree had several coconuts in it as seen in FIG. 1. I then gave the command to lower myself to the ground. At that moment I went sailing down past the coconuts, barely missing the tree! Finding myself on a pathway through the tropical forest, I then came to an extremely long wooden bridge which crossed over a river gorge. On the other side of the bridge I could see three soldiers running toward me as shown in FIG. 2. The two soldiers in front were carrying rifles and wearing light blue berets. The man running behind them was wearing an officer's cap with a red band. My first reaction was that I was going to be shot. I edged over on the right side of the wooden railing. They ran right past without seeing me. I then asked to see the building that these soldiers were guarding. Everything went dark, and then I found my spiritual eye peeking out of the floor of a computer room as seen in FIG. 3. There was one man using a computer on the opposite side of the room near an open door. He got up from his chair and came over to sit in front of a second computer located a few feet from where I was located. From the glare of the computer monitor, I could clearly see his face. Everything went dark as my spiritual eye and body projected back to my physical body.

Another time my spiritual eye, spiritual body and mind were standing outside the closed front door of my condominium. Upon patting my legs with my hands, I couldn't find the keys in my trousers. When I looked down, I realized I wasn't in my physical body. I then shot through two solid walls of concrete and returned to my awakening body.

What these two examples show is that the human spiritual energy system is modular. The reason it is modular is because there are seven hyperspace co-dimensions, each vibrating at a slightly different frequency, which receive energy from space through seven vortices located along the physical body. Over a lifetime, these vortices build up the human aura. Because all energy systems have to be grounded, the remaining six modules are the legs, body, arms/hands, voice, eye and mind. When the entire group is out-of-body as a single entity, then the soul energy powers the body in a manner similar to a battery. The soul looks like a two-inch diameter orange ball of plasma. If the soul is removed from the body, then the body becomes paralyzed except for a small movement of the eyelids. Upon death, all these separate modules are assembled into a single energy being. A light cord from the soul provides the battery power and information required to join these modules together. A second light cord from the pituitary gland transfers the modules into the energy being for assembly. This energy information transfer is the reason that people in a near-death situation say they saw their entire life flash before them.

Moving to a larger picture of things that are happening in the galaxy, I was able to make contact with the Pleiadian Federation which is located about 400 light years from earth. The Federation is a group of over one hundred intelligent beings that were brought to the Pleiades from around the galaxy. One member of the Federation calls itself the Intelligent Insect Beings. They are the ones who fly the black triangles over Belgium and France for the purpose of evacuating human beings back to the Pleiades for relocation on a planet called Earth II. The reason for this evacuation was that it was not known if it would be possible to win the battle of Revelations, which would take place about two years later here on earth.

As could be expected, the humans were angry and hysterical at being abducted. So the Intelligent Insect Beings asked me if I could calm them down. I was in telepathic communication with them, and they were in telepathic communication with their computer system, which meant that I could have my thoughts displayed to the humans on the computer monitor. It turned out that one woman was from Central America and only spoke Spanish. The Intelligent Insect Beings didn't speak Spanish so they thought there would be no way I could communicate with her. So I told them that I would spell the Spanish words letter-by-letter and she could then read my message. Since most Spanish people are Catholics, I thought a religious message would be of importance to her. I spelled out the phrase, “Que Dios te bendiga.” which means, “May God bless you.” I also asked the two beings to put their hands together in a form of prayer, and the woman followed suit. At that moment the Intelligent Insect Beings were reading her mind to understand her emotional state. They said, “She is crying tears . . . ” After a slight but tense pause, they continued, “of joy!” They said the woman had a big smile on her face and was successfully transitioned into her new life.

One year later, the Blond Aliens of the hundred member council of the Pleiadian Federation remote viewed me so that I could celebrate with them the success of their mission to earth. The Blond Aliens, which is not their real name, fly the Beamship spacecraft. This hyperspace vehicle can teleport itself to any location in the galaxy. It dematerializes into the black void for an instance and then re-materialize anywhere in the galaxy. This ship can be seen in Billy Meier's video from Switzerland along with a picture of their envoy, Semjase.

Just recently I had a demonstration of the Beamship's ability. I heard an emergency distress call by a commander of a spacecraft who said that they had a fire onboard their spacecraft. I immediately remote viewed a Federation maintenance mothership, they got the frequency and location of the ship, and dispatched the Beamship in time to rescue the commander. The burned-out cables, which had caused the fire, were repaired by the Federation and the commander arrived home safely on his planet in his own spacecraft.

The Federation then received a message from the commander saying that he wanted his planet to join the Federation now that there was this type of communication available. So the Federation visited his planet for the signing ceremony, and I was invited to attend the proceedings by remote view. Word got around about this, and within three weeks another 20 planets joined the Federation for the same reason.

At one ceremony, which was attended by Admiral Third Class of the Pleiadian Defense Department, His Highness of the planet was signing the document of incorporation. At that moment, I could see him signing, so I exclaimed, “He is signing with his left hand.” The Admiral was almost apoplectic at hearing this. After giving her the signed document, His Highness held up his hand and asked me how many fingers he was holding up. He had a fist so I said none. Then he put his index finger out and I said one. He then made a fist again and I said none. Then he held out all fingers and I said five. The Admiral said that he had a big smile on his face as he went to announce the agreement because he knew, even though his planet was located 90,000 light years away on the other side of the galaxy, he could instantly communicate any problems to the Federation. So this is the importance of developing inventions that can enhance our remote viewing ability because one day it will mean that we can become a vital part of the Pleiadian Federation.

### SUMMARY OF THE INVENTION

Referring to FIG. 4, the spiritual eye of the human energy system is located at the pituitary gland in the forehead. It has the shape of a hollow cone which is composed of the misty white energy of hyperspace. Light coming into this vortex is then transferred by a light cord to a visual energy module which is located in a co-dimension of hyperspace. Because these modules are interconnected by light cords, the mind module is able to interpret the visual pattern the eye is seeing. More importantly, the mind can give logical instructions to this spiritual eye module for it to rotate around or move in a particular direction.

The reason that hyperspace has a white misty look to it is that the speed of light is very much less than the speed of light in our spacetime. The Lorentz transformation says that the distance L is shortened relativistically to a distance L′ in a way related to the ratio of the velocity v of the object to the velocity of light c.

$${L}^{′} = L \sqrt{1 - \frac{{v}^{2}}{{c}^{2}}}$$

If the velocity of light is very low, then a small velocity creates an enormous contraction in length. By moving through hyperspace, therefore, enormous distances can be traversed. And this is the reason that it is possible to project the spiritual eye, voice and hearing to remote locations in the galaxy.

The universe is composed of subspace, space and hyperspace which are co-dimensions of each other. Subspace is defined by the geometry of the tetrahedron which is a four-sided solid whose faces are equilateral triangles having three 60° angles. Referring to FIG. 5, a tetrahedron whose sides are the square root of three (A), has a height of the square root of two (B), and base length equal to the square root of one (C). This forms the basic number set {\sqrt{1}, \sqrt{2}, \sqrt{3}}.

Referring to FIG. 6, the tetrahedron (A) is circumscribed by the sphere (B). Rod (C) is the sphere radius. A second rod (D), of equal length to rod (C), from the center of the sphere to the corner of the tetrahedron makes an angle φ of

$$ϕ = ArcSin ( \frac{1}{3} ) = {19.47122063}^{∘}$$

So the four corners of the tetrahedron touch the sphere.

This tetrahedral geometry can be seen throughout the planets of the solar system Referring to FIG. 7, the islands of the Caribbean curve down from Puerto Rico to Venezuela forming an island vortex. The low density hyperspace energy releasing from the corner of the tetrahedron softens the rock mantle. The hot magma then rises through the rock with the least resistance. This creates a circular arc of volcanic islands along the edge of the vortex.

Referring to FIG. 8, the Giant Red Spot of Jupiter is located at a southern latitude of 19.5°. This vortex is so large that the entire earth can fit in it.

Referring to FIG. 9, the Olympus Mons volcano is located at a northern latitude of 19.5° as shown by the marker. This volcano is the size of France. Notice the fallen plume of volcanic debris toward the north east.

The double harmonic of the tetrahedral angle is twice 19.5° or 39° which is the location of the Silver Bridge in Point Pleasant, West Va. A large wormhole opened up around the bridge during Christmas rush hour when the bridge was full of cars. Due to the low density hyperspace energy, the rivets holding the cables down popped loose and all the cars were dumped into the river. A computer simulation using Schrodinger's quantum mechanics equation for a particle in a potential well shows that as the energy becomes less dense, the particle is no longer contained in the potential well. The electron jumps out. Thus the atomic bonds are broken which softens the rivets. This is the first time that there has been an understanding of the failure mechanism of this bridge.

After downloading from the Internet several pages of the index of refraction of a wide range of materials, I noticed that the index of refraction for Plexiglas was 1.50. Another source said it was 1.51. One of the Internet sites had a movable flashlight which showed the incident ray and the refracted ray. For Plexiglas, surprisingly enough, the incident ray was coming in at an angle of 60° to the normal, and the light was refracted at 35.26°, both of which are tetrahedral angles. The angle of the equilateral face of the tetrahedron is of course 60°. The angle at the top of tetrahedron is the arc-cosine of the ratio of the height over the edge length.

$$θ = ArcCos ( \frac{\sqrt{2}}{\sqrt{3}} ) = {35.26}^{∘}$$

According to Snell's law, the index of refraction n, times the sine of the angle sin(θ₁) of the ray leaving material m₁, is equal to the index of refraction n₂ times the sine of the angle of refraction sin(θ₂) of the ray entering material m₂. Referring to FIG. 10, the equation is
n₁ sin(θ₁)=n₂ sin(θ₂)
The index of air n₁ is equal to one. The index n₂ of Plexiglas is 1.50. If the incident ray is at θ₁=60° to the normal, then the output angle is

$${θ}_{2} = ArcSin [ \frac{{n}_{1}}{{n}_{2}} Sin ( {θ}_{1} ) ] = ArcSin [ \frac{2}{3} \frac{\sqrt{3}}{2} ] = {35.26}^{∘}$$

which is equal to the angle of the tetrahedron.

Then I recalled several months earlier that I had gone to the Subway restaurant to get a sandwich. I was sitting by the Plexiglas window communicating with the Admiral whose mothership was in earth orbit. She mentioned that they were bringing two people aboard. At that moment I looked out through the window and I could see both of them clearly and easily through my spiritual eye. To my amazement, I saw both of the captives start to pull out guns from behind their backs. I then projected by spiritual hands which resulted in preventing the attack on the security guards. To say the least, the Admiral was rather surprised at these events. She then asked me to look at the design of the window because she thought it had something to do with my enhanced remote viewing capabilities. Looking at the Plexiglas, I noticed that on the edge of the large window pane there was a shorter piece of Plexiglas which was mounted parallel to the window pane. This smaller panel acted to protect the yellow neon fluorescent tube. I took the measurements of the design using a piece of paper that I found near the table.

I then went home and designed up a mounting bracket with my 3D computer software. I had already installed the stereolithography software that converts the design to the *.STL file format. How stereolithography works is that it slices the design into many thin horizontal sections. The machine has a platform which is mounted in a bath of liquid polymer. An ultraviolet laser, mounted on an xy-table, then traces out the slice. Because the liquid polymer is light sensitive, it polymerizes immediately into solid plastic. Then the platform is lowered a few thousandths of an inch and the second slice is added. This process eventually builds up the complete 3D part. Using the Internet, the *.STL file is sent by e-mail to the stereolithography service provider who returns the part overnight. So the next day I had the piece from which I made a plastic mold and several additional pieces for mounting the Plexiglas bracket on a full sheet of Plexiglas that I ordered locally. It never occurred to me to measure the angles, so after I got the index of refraction for Plexiglas, I measured the incident angle and it turned out to be 61°. So then I realized that the spiritual eye was being diffracted across these two Plexiglas plates which connected it to the tetrahedral geometry of subspace. Because subspace is the foundation of space, this created a much more efficient route for remote viewing. The result is that this invention has allowed me to make contact with 430 alien civilizations. Since then I have been awarded the Aphysics prize for my work in the invention and elaboration of the tetrahedron diagram of which there are now over 4000 graphs. The scientific discoveries contained in the diagram are (1) the electron and proton are one and same particle, (2) the existence of hyperspace, (3) how mass can be taken out of dimension, (4) cosmology determines the elementary particles, (4) all the physics constants and the tetrahedral geometry are contained in the two 360° circles of the infinity symbol and (5) all the physics constants are determined geometrically and projected from a subspace manifold into our dimension. For my work in Revelations, I was awarded four beautiful galloping riderless white horses of the Apocalypse.

### A BRIEF DESCRIPTION OF THE DRAWINGS

FIG. 1. Remote viewing the top of a palm tree containing several coconuts.

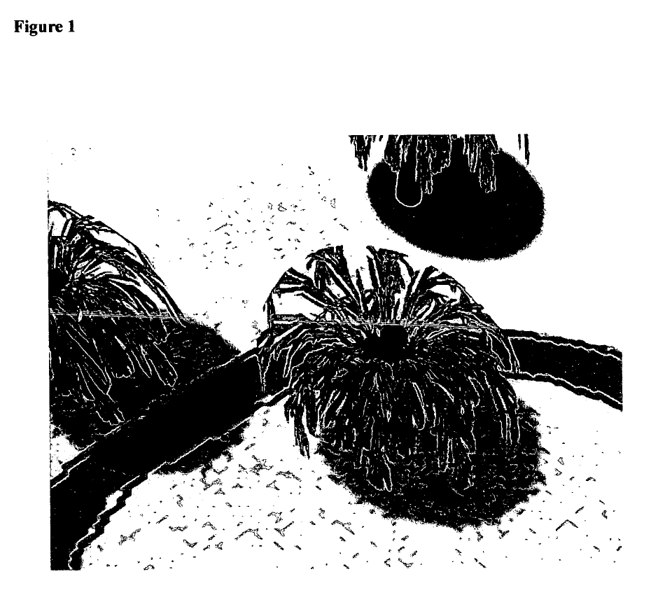

FIG. 2. Remote viewing three soldiers running across a wooden bridge.

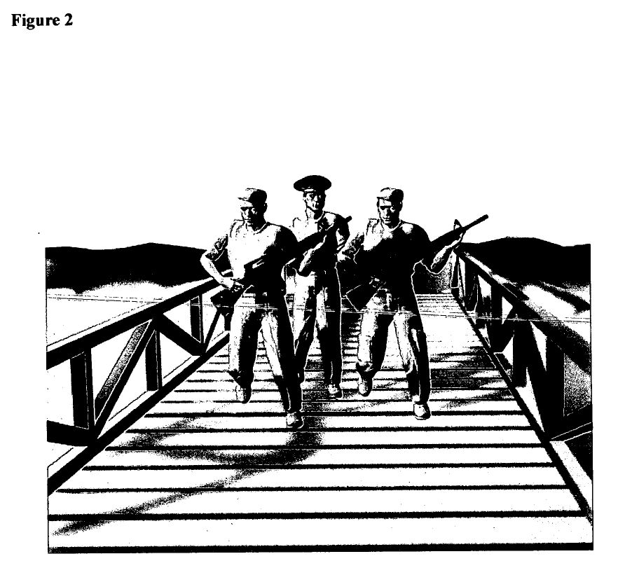

FIG. 3. Remote viewing computer building that soldiers were guarding.

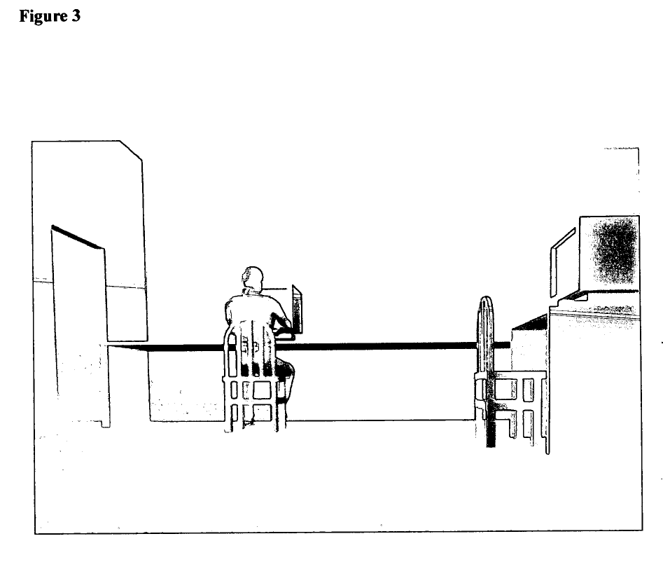

FIG. 4. Spiritual eye of human aura.

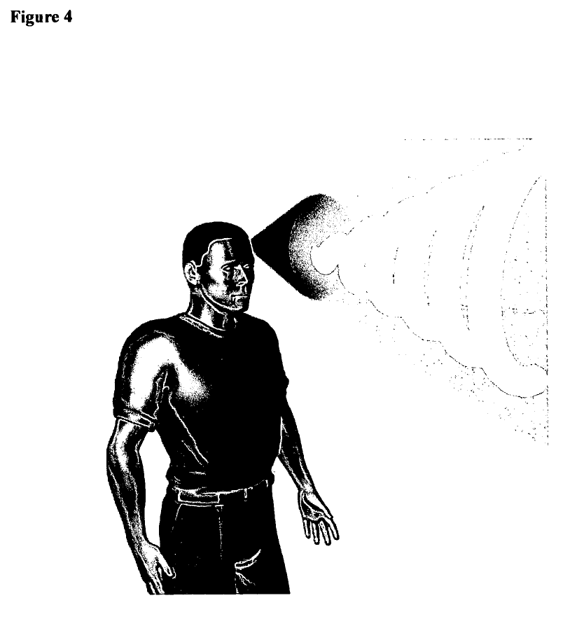

FIG. 5. Tetrahedron.

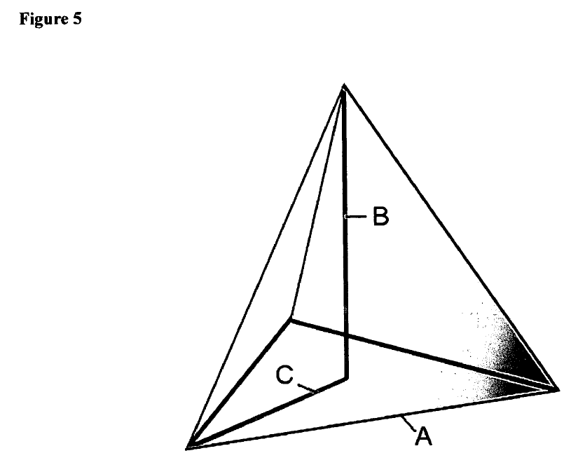

FIG. 6. Tetrahedron circumscribed by sphere.

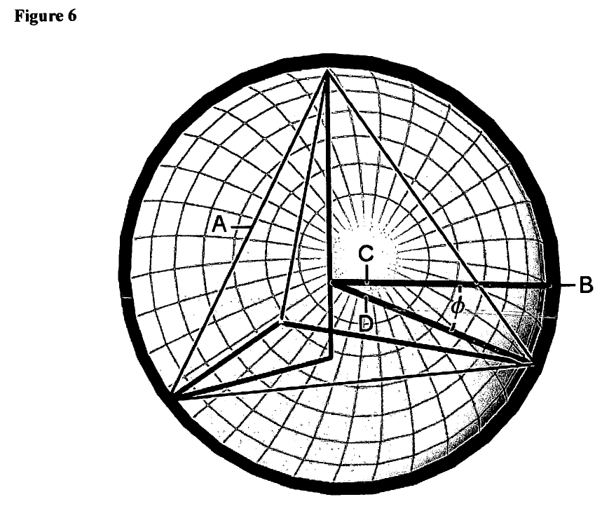

FIG. 7. Caribbean volcanic island vortex.

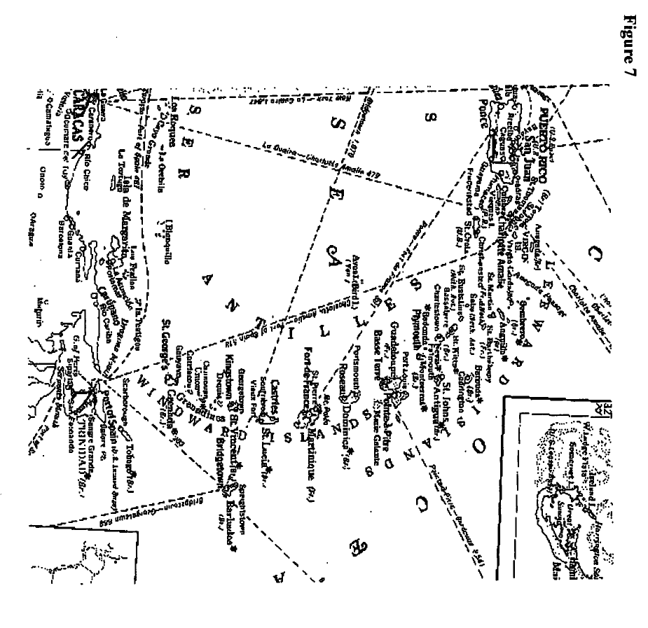

FIG. 8. Giant Red Spot on Jupiter.

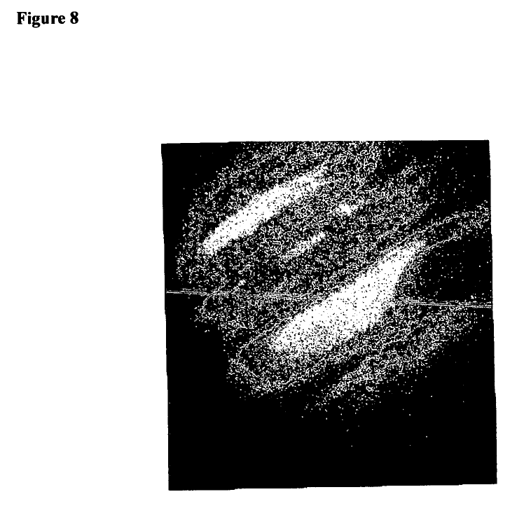

FIG. 9. Olympus Mons volcano on Mars.

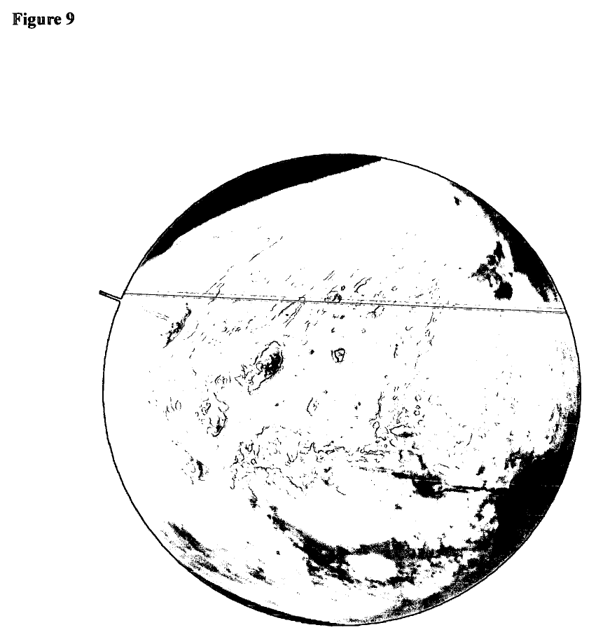

FIG. 10. Snell's Law of Refraction.

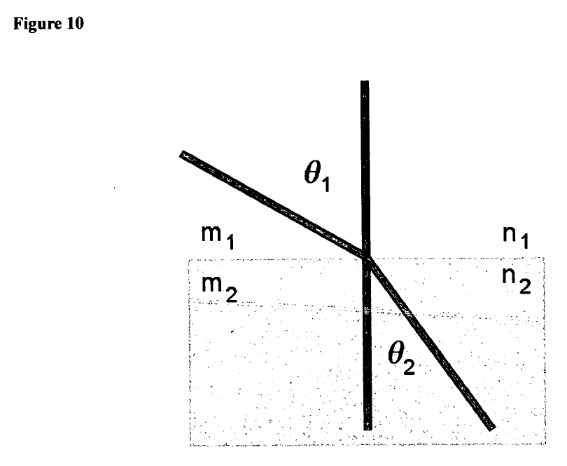

FIG. 11. Perspective view of remote viewing station.

FIG. 12. Wedge-shaped spacers for diffraction panel.

FIG. 13. Remote viewing angle.

FIG. 14. A remote viewing session taking place on a planet located 90,000 light years from earth on the other side of the galaxy showing His Highness signing with his left hand the document that allows his planet to become a member of the Pleiadian Federation.

### DETAILED DESCRIPTION OF THE INVENTION

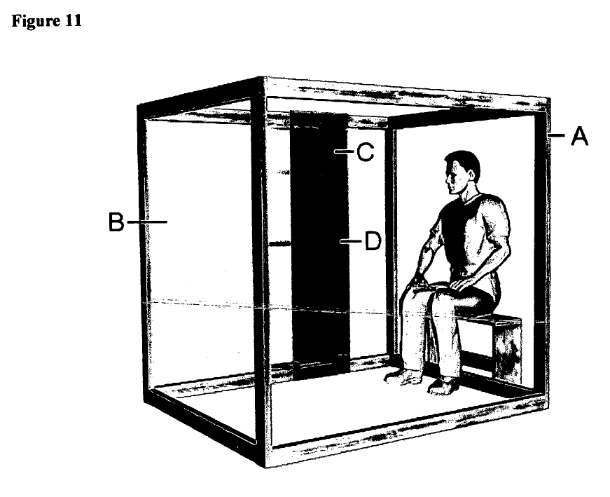

1. Referring to FIG. 11, the remote viewing station is a rectangular box wooden frame (A) on which is mounted on one side a large sheet of Plexiglas (B). The diffraction panel (C), made of a shorter length of Plexiglas, is mounted with acrylic glue on the Plexiglas sheet using clear polyoptic molded plastic spacers (D).

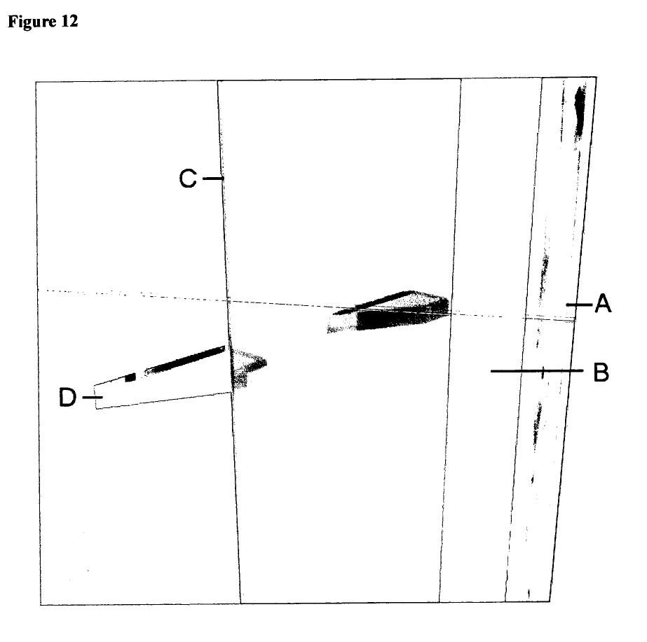

Referring to FIG. 12, the wedge-shaped spacers (D) hold the diffraction panel (C) to the sheet of Plexiglas (B). The angle of the wedge is 30° which makes the incident angle 60° to the normal.

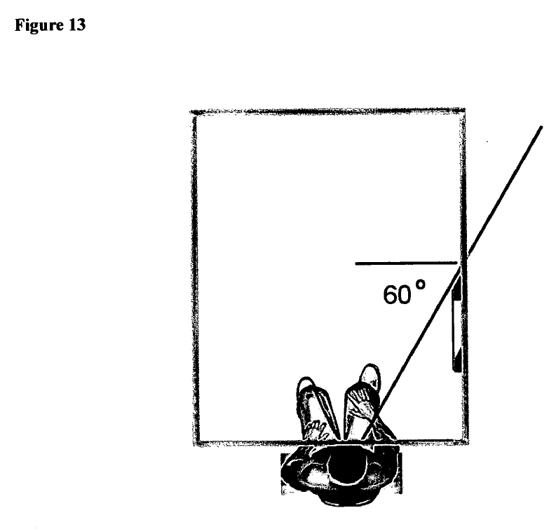

Referring to the top view perspective FIG. 13, sitting on the wide bench, the remote viewer can adjust his sight along the wedge for proper alignment at an angle of 60°. Due to the 1.50 index of refraction of Plexiglas, the spiritual eye is diffracted across the edge of the first panel and then refracted across the second panel at the tetrahedral angle of 35.26°.

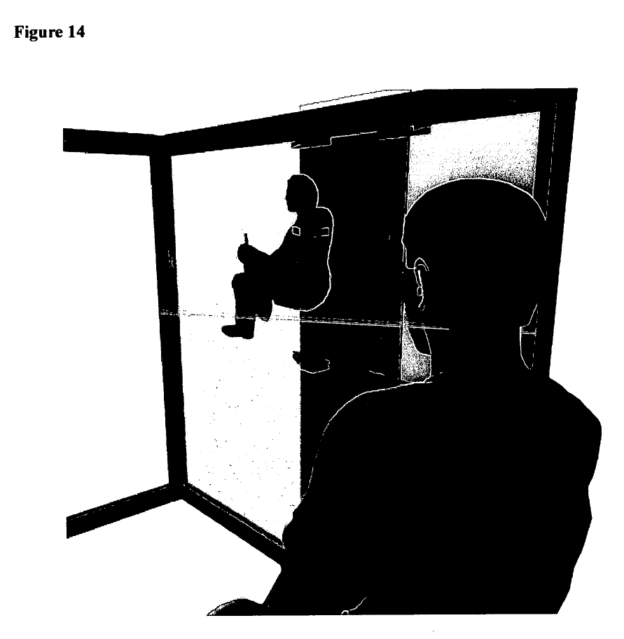

Referring to FIG. 14, the remote viewing image is seen superimposed on the large sheet of Plexiglas which acts as the viewing screen.

I claim:

1. A remote viewing station comprising:
(a) a rectangular box frame made of wood having a length of six feet, a width of four feet and a height of six feet;
(b) a large sheet of quarter inch Plexiglas, having an index of refraction of 1.50, mounted on the right side of item (1a);
(c) several wedge-shaped clear plastic spacers, three inches in width and eight and a half inches in length, having a wedge angle of 30° that are mounted on the interior right side of item (1b);
(d) a shorter sheet of quarter inch Plexiglas, having a length of one and a half feet, mounted on item (1c) parallel to item (1b);
(e) a wide bench on which the remote viewer sits so that the remote viewer can align his sight along the wedge angle of item (1c);

2. A remote viewing amplifier that:
(a) diffracts the spiritual eye of the remote viewer across the edge of item (1d) at an incident angle of 60° to the normal;
(b) refracts the spiritual eye at 35.26° to the normal due to the refractive index of item (1a) according to Snell's Law of Refraction; and
(c) aligns the spiritual eye with the tetrahedral geometry of subspace due to the diffraction/refraction combination of item (2a) and (2b).
